(19) United States
(12) Patent Application Publication
(10) Pub. No.: US 2013/0219483 A1
(43) Pub. Date: Aug. 22, 2013

(54) CONTENT FILTERING APPARATUS AND METHOD

(71) Applicant: Pantech Co., Ltd., (US)

(72) Inventors: Young Tak CHO, Seoul (KR); Jin Man Park, Seoul (KR)

(73) Assignee: Pantech Co., Ltd., Seoul (KR)

(21) Appl. No.: 13/670,927

(22) Filed: Nov. 7, 2012

(30) Foreign Application Priority Data
Feb. 22, 2012 (KR) 10-2012-0018009

(51) Int. Cl. G06F 15/16; G06F 21/00

(52) U.S. Cl. 726/13; 709/231

(57) ABSTRACT

A content filtering apparatus may include a receiving unit to receive a data stream constituting content from at least one cloud server, a filtering unit to filter the content based on a service profile and a filtering condition corresponding to the at least one cloud server, and a control unit to search for data, in the data stream, associated with the filtering condition based on an index of the service profile matching the filtering condition.

### CROSS-REFERENCE TO RELATED APPLICATION

This application claims priority from and the benefit of Korean Patent Application No. 10-2012-0018009, filed on Feb. 22, 2012, which is hereby incorporated by reference for all purposes as if fully set forth herein.

### BACKGROUND

1. Field

Exemplary embodiments of the present invention relate to an apparatus and method for filtering contents received from various cloud services.

2. Discussion of the Background

An increasing number of companies, as well as individuals, are using the cloud services. A cloud service may refer to a service that enables a service user to store content in a server and access said content using various types of terminals, thereby allowing for easy reading or sharing of a desired content irrespective of a time, a region, and an apparatus.

As cloud services evolve into content sharing platforms between individuals, groups, and companies, it is expected that the cloud services will be used more actively in various fields beyond use as a simple individual web storage platform.

If cloud services are used in various fields, there is a desire to inter-operate cloud services being currently managed in a closed manner so as to create an environment in which content sharing and cooperative operating is feasible.

As the use of cloud services spreads, contents may be shared more freely and security threats may increase. The severity of the effects of malicious contents being spread may become intensified in a cooperative operating environment. In particular, as technologies applied to mobile terminals have been developed to reach the level of technologies applied to personal computers, it is expected that malicious contents may attack mobile terminals.

If a user intends to download an arbitrary application from an android market, the user may be notified of a system privilege required for the corresponding application. However, this notification transmits information about the system privilege to the user, and if an application including a malicious content requires an unnecessarily broad privilege, fails to block the application.

If the user lacks an understanding of how the notified privilege is used and downloads the application including the malicious content, issues including leakage of personal information of the user, leakage or destruction of a confidential business material stored in a mobile terminal of the user, and the like may arise.

The foregoing may be applied to a cloud services. In particular, if a function of blocking security threats hidden in contents received through cloud services is absent in a content receiving apparatus, or such a function is provided but fails to meet a level desired by a user, other users, companies, and public authorities beyond the individual user or one mobile terminal may be exposed to security threats, depending on characteristics of cloud services.

In a cooperative operating environment in which a cloud service A without a security policy inter-operates with a cloud service B with an arbitrary security policy, from a perspective of a user, there may exist a doubt regarding the reliability of contents to be provided from the cloud service A in an unlimited manner.

### SUMMARY

Exemplary embodiments of the present invention provide a content filtering apparatus to filter content received from a cloud service.

Exemplary embodiments of present invention also provide a method for filtering inappropriate content received from a cloud service.

Additional features of the invention will be set forth in the description which follows, and in part will be apparent from the description, or may be learned by practice of the invention.

An exemplary embodiment of the present invention discloses a content filtering apparatus, including: a receiving unit to receive a data stream including contents from at least one cloud server; a filtering unit to filter the content based on a service profile and a filtering condition corresponding to the at least one cloud server; and a control unit to search for data, in the data stream, associated with the filtering condition based on an index of the service profile matching the filtering condition.

An exemplary embodiment of the present invention also discloses a method for filtering inappropriate content, including: receiving a data stream from a cloud service including a service profile of the cloud service; determining a filtering policy to filter the data stream including a filtering condition; mapping the service profile to the filtering policy to generate an index mapping table; determining if the data stream meets the filtering condition using the index mapping table; and blocking reception of the data stream if the filtering condition is met.

An exemplary embodiment of the present invention also discloses a method for buffering content in a mobile terminal, including: generating a receiving data buffer; receiving a data stream including content in the receiving data buffer; storing a copy of the content stored in the receiving data buffer in a filter buffer; determining if the copied content in the filter buffer meets a filtering condition of a filtering policy; and if the filtering condition is met, blocking the reception of data in the receiving buffer.

An exemplary embodiment of the present invention also discloses a method of generating a standard service profile, including: receiving a first service profile of a first cloud service; mapping an index of the first service profile to an index mapping table of the standard service profile; determining if the first service profile is to be modified according to the standard service profile; modifying the first service profile according to the standard service profile if the first service profile is to be modified; and storing the mapped index of the first service profile.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram of a cloud service access environment according to a related art.

FIG. 2 is a block diagram of a content filtering apparatus according to an exemplary embodiment of the present invention.

FIG. 3 is a block diagram of a content filtering apparatus according to an exemplary embodiment of the present invention.

FIG. 4 is a block diagram of a content filtering apparatus according to an exemplary embodiment of the present invention.

FIG. 5 is a diagram a method for transmitting received data according to an exemplary embodiment of the present invention.

FIG. 6 is a diagram of a method for adaptively adjusting a size of a filter buffer according to an exemplary embodiment of the present invention.

FIG. 7 is a diagram of a data stream according to an exemplary embodiment of the present invention.

FIG. 8 is a diagram of method for re-generating a service profile according to an exemplary embodiment of the present invention.

FIG. 9 is a flowchart of a method for content filtering according to an exemplary embodiment of the present invention.

FIG. 10 is a flowchart of a method for data buffering according to an exemplary embodiment of the present invention.

FIG. 11 is a flowchart of a method for searching, modifying, and generating a service profile according to an exemplary embodiment of the present invention.

FIG. 12 is a flowchart of a method for searching and adding a filtering policy according to an exemplary embodiment of the present invention.

### DETAILED DESCRIPTION OF THE ILLUSTRATED EMBODIMENTS

Exemplary embodiments are described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element is referred to as being “directly connected to” another element, there are no intervening elements present.

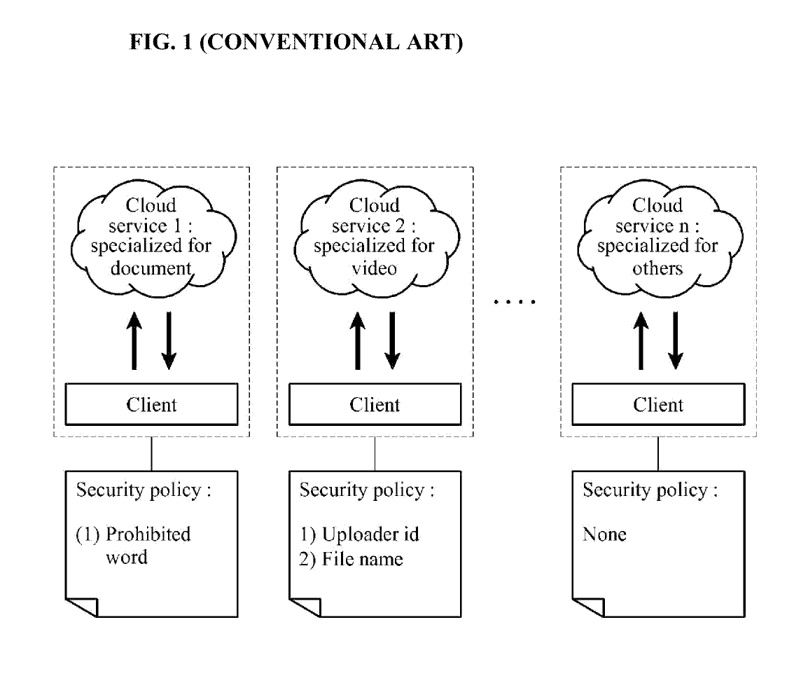

FIG. 1 is a diagram of a cloud service access environment and according to a related art.

Referring to FIG. 1, the cloud service access environment may include a cloud server having a storage, a client, and a security policy. The client may be operating in a mobile communication terminal, a desktop computer, a smart TV, and the like that is accessible to the cloud server.

The cloud service may be specialized for a reference type of content, or may be designed to share all contents.

Generally, the terminal may transmit account information through a dedicated client of the cloud service, and if the terminal receives access authentication, may obtain a list of contents, that is stored in the cloud server, for which sharing may be permitted.

A user may select content in the obtained list of contents and download the corresponding content, or may upload content stored in the terminal to the cloud server and edit or delete the content stored in the cloud server.

The security policy may correspond to a standard for determining reference content among contents of the cloud server to be a malicious content. For example, the security policy may include a prohibited word, an uploader identification (ID), a file name, and the like.

The security policy may be applied if accessing the cloud server to search for content or searching for content stored in the cloud server. The security policy may not be set in the cloud service. The security policy may be variously utilized depending on a purpose of the cloud service, a service management model of a service provider, and experience of the user.

For example, a first cloud service may correspond to a service specialized for a text content, and a client of the first cloud service may filter undesired content deemed to be “bad” due to the inclusion of a prohibited word in a document. The user may directly add, delete, and change the prohibited word using the client of the first cloud service. As used hereinafter, “bad content” may be used to describe content that fails to comply with a security policy.

The first cloud service may transmit request signals and response signals to and receive request and response signals from the client for service subscription, user authentication, reference/generation/deletion/name change of service list, sharing document list reference, and uploading, downloading, or deleting a document.

In the first cloud service, content additional information, for example, information shown in Table 1 may be added to a data stream and transmitted using a hypertext transfer protocol (HTTP) POST method. For example, the content additional information may be configured as metadata.

TABLE 1

| Metadata tag | Meaning | Format |
|---|---|---|
| Magic number | Magic number | Binary |
| <content-title></content-title> | Content title | Text |
| <content-file></content-file> | Name of actual file | Text |
| <author></author> | ID of first sharer/publisher/ | Text |
| | uploader | |
| <date></date> | First uploaded date | Integer |
| <doc-ver></doc-ver> | Document version | Integer |
| <last-update></last-update> | Last updated date | Integer |
| <content-size></content-size> | Size of actual text data | Integer |
| Text data | Actual text data | Text |
| </eot> | End of transmission identifier | None |

The first cloud service may transmit through one data stream data including additional data and text data as shown below:

<content-title>Marketing Presentation</content-title>
<content-title>marketing.ppt</content-title>
<author>humankim</author>
<data>20111205</data>
<doc-ver>1110<doc-ver>
<last-update>20111206</last-update>
<content-size>29060</content-size>
<data>01010000010010001(...omitted...)0101010101001001</data>
</eot>

A second cloud service may correspond to a service specialized for a video, and a client of the second cloud service may block bad content using an uploader ID, and may block an illegally copied film content using a file name. The client may download an ID of a user uploading bad content and a file name list of the bad content from the cloud service to periodically update a security policy.

The second cloud service may transmit request signals and response signals to receive request signals and response signals from the client software for service subscription, user authentication, reference/generation/deletion/name change of service list, sharing video list reference, and uploading, downloading, or deleting of video.

In the second cloud service, a separate data stream for age authentication using an HTTP POST method may be added as well as a data stream for video sharing.

The second cloud service may use a file transfer protocol (FTP) in sharing a video file, and may transmit additional content information, for example, additional information shown in Table 2, through a separate data stream of an HTTP POST method.

TABLE 2

| Metadata tag | Meaning | Format |
|---|---|---|
| <movietitle></movietitle> | Content title | Text |
| <filename></filename> | Name of actual file | Text |
| <filmedby></filmedby> | Film maker name | Text |
| <presentedby></presentedby> | Distributor name | Text |
| <copyrightinfo></copyrightinfo> | Copyright information | Text |
| <uploader></uploader> | ID of first sharer/publisher/ | Text |
| | uploader | |
| <uploaddate></uploaddate> | First uploaded date | Integer |
| <runningtime></runningtime> | Total running time | Integer |
| <genre></genre> | Genre identifier | Integer |
| <director></director> | Director name | Text |
| <actor></actor> | Actor list | Text |
| <rating></rating> | Film rating identifier | Integer |
| Etc. | Etc. | Etc. |

If a subtitle file, for example, *.smi file and the like, is present, the subtitle file may be transmitted through a data stream of an HTTP POST method. The subtitle file may be a separate file.

Unlike the cloud service 1, the second cloud service may transmit actual data through a data stream including additional data as shown below, and may transmit a video file through a separate data stream after transmitting the additional data.

<movietitle>Breaking dawn</movietitle>
<filename>breaking_dawn_720p.avi</filename>
<filmedby>Warner Brothers </filmedby>
<presentedby>CJEnMpictures</presentedby>
<copyrightinfo>5781110</copyrightinfo>
<uploader>hum ankim</uploader>
<uploaddate<20111203</uploaddate>
<runningtime>120</runningtime>
<genre>FantasyBlockbuster</genre>
<director>Bill Condon</director>
<actor>Kristen Stewart, Robert Pattinson, Taylor Lautner</actor>
<rating>88</rating>

An Nth cloud service may support various types of contents without a security policy or without a specific security policy, and a client of the Nth cloud service may download various types of contents.

Similar to the first cloud service, the Nth cloud service may transmit request and response signals to and receive request and response from the client for membership subscription, user authentication, virtual folder management, content list reference, and the like, however a configuration of transmitted data and received data may be different from that of the first cloud service.

The Nth cloud service may transmit a plurality of files through one data stream, and the data stream may be configured as shown in Table 3. Data and additional information may be included in one data stream. The Nth cloud service may generate a data stream in bytes without a separate tag for identifying data. Accordingly, the Nth cloud service may set a size of metadata by recording data in a reference setting section and zero-padding the remaining space.

TABLE 3

| | | |
|---|---|---|
| Metadata tag | Meaning | Format |

| | |
|---|---|
| 1 byte (first byte) | Number of files to be transmitted |
| 1024 bytes (from fifth byte) | Additional information of file 1 |
| Binary data | Actual data of file 1 |
| 1024 bytes | Additional information of file 2 |
| Binary data | Actual data of file 2 |
| 1. And so on | 2. . . . |
| 512 bytes | File name |
| 16 bytes | File size |
| 496 bytes | Advertising data recognizable by |
| | dedicated client S/W |

However, if an individual, a company, or a government agency intends to control content sharing through each cloud server according to a conventional method, one united security policy may not be applied to the cloud services. This is because different types of clients are used for each cloud service and security policies are set and displayed differently for each client.

In a related art, content provided through a cloud service may be verified after downloading. Content having a security threatening factor may be downloaded and then verified. In the related art, the amount of cost and time involved in transmitting data and a memory may be increased by downloading and verifying content having a security threat. If content is installed or executed in a terminal after being downloaded, a malicious function embedded in the content may become operational.

Even if an anti-virus program is utilized, there is a desire to block a security threatening factor beginning at the time of receiving software or content from a cloud service because, in the related art, the software or content is verified after being installed in a terminal.

Exemplary embodiments of the present invention may recognize various cloud services as one virtual cloud service, may allow a user or an information security manager to add a security policy for a cloud service, and may block a malicious content in a process of transmitting and receiving software or content.

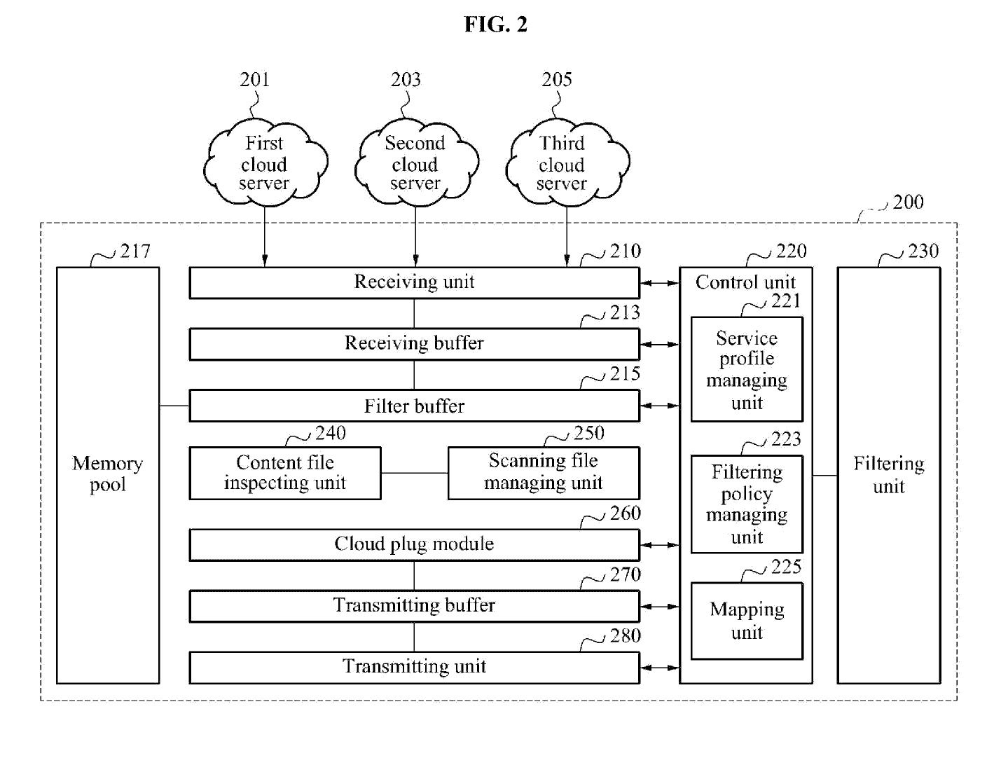

FIG. 2 is a block diagram of a content filtering apparatus according to an exemplary embodiment of the present invention.

Referring to FIG. 2, a content filtering apparatus 200 may include a receiving unit 210, a control unit 220, and a filtering unit 230.

The receiving unit 210 may receive content from at least one cloud server. The content may be configured in a form of a data stream. The receiving unit 210 may receive content from a first cloud server 201, a second cloud server 203, and a third cloud server 205, using a cloud plug module 260.

The cloud plug module 260 may correspond to a module to access each cloud server based on each access scheme. To access the first cloud server 201, the cloud plug module 260 accessible to the first cloud server 201 may be used. The receiving unit 210 may include the cloud plug module 260 corresponding to the first cloud server 201, the second cloud server 203, and the third cloud server 205.

The data stream received through the receiving unit 210 may be stored in a receiving buffer 213. The receiving buffer 213 may store a reference size of data constituting the data stream.

The input and output of a file through a storage may overload a system load and may result in a bottle neck due to a difference between a processing rate of a main memory and an input rate and output rate of a storage. The receiving buffer 213 may act as a pipeline to improve efficiency in input of data to and output of data from a file system. The main memory may include, for example, a memory, and the storage may include, for example, a hard disc, a secure digital (SD) card, and the like.

A filter buffer 215 may have a variable size depending on a size of data associated with a filtering condition. The filtering condition may be determined based on a filtering policy of each cloud service, and may be determined by a cloud service provider, a cloud service user, a cloud service manager, and the like. The filtering condition may correspond to a condition for failing to store content in a file system, if the content meets a reference condition, and may include, for example, a prohibited word, a file name, an ID, and the like.

The size of data to be extracted by the filtering unit 230 may vary depending on the filtering condition. The size of the filter buffer 215 may be variably adjusted, thereby reducing unnecessary memory usage.

The filter buffer 215 may store a copy of data associated with the filtering condition stored in the receiving buffer 213. The copy stored in the filter buffer 215 may be used by the filtering unit 230 to determine whether an item corresponding to the filtering condition is included in the content.

A memory pool 217 may include a plurality of memory blocks. The memory block may be determined based on the size of the receiving buffer 213. For example, the memory block may have a size corresponding to 1:1, 1:2, or 1:4 of the size of the receiving buffer 213. The filter buffer 215 may have a size that may be variably adjusted depending on the number of memory blocks assigned from the memory pool 217.

The control unit 220 may search for data associated with the filtering condition in the data stream. The control unit 220 may use an index of a service profile matching the filtering condition. The control unit 220 may identify the filtering condition based on the index of the service profile. The control unit 220 may search for a corresponding type of data in the data stream.

The index of the service profile may be determined based on an index mapping table. The index mapping table may correspond to a table in which an index is mapped to the filtering condition based on filtering policies of the registered cloud services. The index may be mapped to a transfer protocol of the service profile based on the index mapping table.

The control unit 220 may adjust the number of memory blocks assigned to the filter buffer 215 based on the size of data associated with the filtering condition. The control unit may adaptively adjust the number of memory blocks assigned to the filter buffer 215.

The control unit 220 may adjust the number of memory blocks assigned to the filter buffer 215 based on a location of data associated with the filtering condition in the receiving buffer 213, an amount of time taken to identify the filtering condition, and an amount of time taken to flush the data stored in the receiving buffer 213.

If the receiving buffer 213 is fully filled with the data stream, the data stored in the receiving buffer 213 may be copied to the filter buffer 215 or may be stored in a file on the file system. As used herein, ‘flushing’ or ‘to flush’ may correspond to clearing the receiving buffer 213 of data.

The control unit 220 may include a service profile managing unit 221, a filtering policy managing unit 223, and a mapping unit 225.

The service profile managing unit 221 may load, modify, delete, and generate a service profile. The service profile may include information to access at least one cloud server and configuration information of a data stream.

The service profile may be generated for each cloud service, and may include a content transmitting procedure, a data stream identifying scheme, a communication protocol to transmit a data stream including, for example, HTTP, FTP, and the like. The configuration information of the data stream may indicate whether data is configured as metadata or a location in which data is stored in the memory, and may be used to distinguish additional data and actual data of the data stream.

The filtering policy managing unit 223 may load, modify, delete, and generate a filtering condition matching an identity value of the service profile based on the filtering policy. The filtering condition may vary depending on the service profile. The filtering condition may be determined based on the filtering policy. The filtering condition and the filtering policy may be stored in a filtering policy database (DB).

The mapping unit 225 may map the index of the index mapping table to the configuration information of the data stream of the service profile based on standard information of the index mapping table. The standard information may correspond to a filtering condition constituting the filtering policies of all the registered cloud services. For example, a file name may be set as standard information. For example, the mapping unit 225 may map an index assigned to the standard information to an item indicating a file name in the configuration information of the data stream of the service profile.

The index mapping table may include a filtering condition determined based on the filtering policies of the registered cloud services and the index assigned to each filtering condition. The configuration information of the data stream may include information about a scheme of transmitting additional information and actual data of the content.

If a new cloud service is added, the control unit 220 may re-generate a service profile of the new cloud service into a united service profile based on the index mapping table, irrespective of a type of the cloud service. The united service profile may further include the index mapped to the configuration information of the data stream of the service profile based on the index mapping table. In other words, the united service profile may be assigned to each service profile based on a standard of the index mapping table.

The control unit 220 may determine whether the item set as the filtering condition is present in the service profile corresponding to at least one cloud server. For example, if a file name of a reference video is set as the filtering condition, and if the file name of the reference video supported by a corresponding cloud service is present in the service profile, the control unit 220 may determine that the item indicating the file name set as the filtering condition is present in the service profile.

The filtering unit 230 may filter the content based on the service profile and the filtering condition corresponding to at least one cloud server. If the control unit 220 determines that the item set as the filtering condition is present in the service profile, the filtering unit 230 may extract data corresponding to the filtering condition, may determine whether the data meets the filtering condition, and if the data meets the filtering condition, may filter the content consisting of the corresponding data.

If data of the content is copied to the filter buffer 215, the filtering unit 230 may verify a location of the data matching the filtering condition from the service profile based on the filtering condition, and may extract the data matching the filtering condition from the filter buffer 215 based on the verified location. The location of the data may be verified through metadata or an address in the filter buffer 215. However, aspects of the exemplary embodiments are not limited thereto and the location of the data may be verified through any method for verifying location of data.

A content file inspecting unit 240 may inspect security of a content file that is received through the receiving unit 210 and stored in the file system. The content file inspecting unit 240 may inspect security of the content file using a third-party anti-virus program. However, aspects of the exemplary embodiments are not limited thereto and the security of the content file may be verified through other anti-virus programs, a vaccine, etc. The security inspection may determine whether a malicious code is included in the content file, whether a malware is included in the content file, and the like. The use of a separate external software, an internal anti-virus program, a vaccine, etc. to inspect the security of the content file may be stated in the filtering policy.

A scanning file managing unit 250 may manage a scanning file including information about a file stored in at least one cloud server and information to access the at least one cloud server. The scanning file may include information associated with an actual file stored in the cloud server and may be recognized as a virtual file of the actual file.

The scanning file may include a file information field, a cloud plug module information field, a cloud dependent information field, and an application data field. The scanning file may be generated by virtualizing the actual file stored in the cloud service.

The file information field may include information associated with the actual file of the cloud service. The cloud plug module information field may include information about the cloud plug module 260 which may access each cloud service. The cloud dependent information field may include information associated with a reference scheme for the cloud plug module to access the cloud service. The application data field may include application data having an undetermined file format.

A transmitting buffer 270 may store data of a size corresponding to a size of a reference area among data constituting the data stream transmitted through a transmitting unit 280. The transmitting buffer 270 may operate between the file system and the transmitting unit 280 and may increase the input and output efficiency of data to and from the file system.

The transmitting unit 280 may transmit the data stream including the content to at least one cloud server. The transmitting unit 280 may transmit the data stream to the first cloud server 201, the second cloud server 203, and the third cloud server 205 through the cloud plug module 260.

If content matching the filtering condition is detected by the filtering unit 230, the control unit 220 may block reception of the data stream including the content, may delete the data of the data stream stored in the receiving buffer 213, and may delete the content file of the data stream stored in the file system. The filtering unit 230 may extract additional data from the data stored in the filter buffer 215, and may determine whether the additional data matches the filtering condition. The control unit 220 may block reception of the data stream before the entire content of the data stream is stored in the file system.

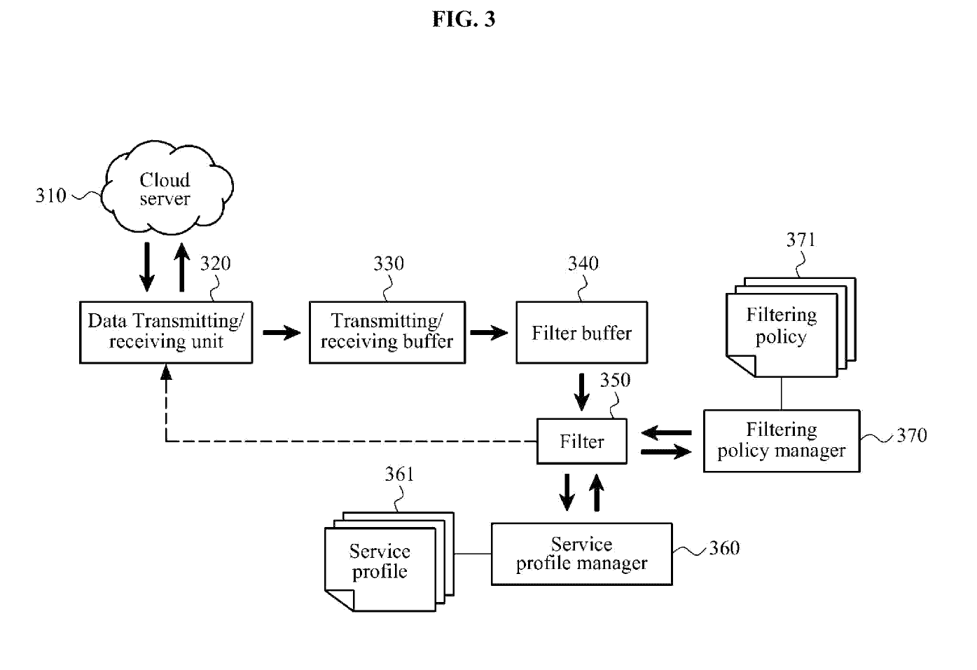

FIG. 3 is a block diagram of a content filtering apparatus according to an exemplary embodiment of the present invention.

Referring to FIG. 3, the content filtering apparatus may include a data transmitting/receiving unit 320, a transmitting/receiving buffer 330, a filter buffer 340, a filter 350, a service profile manager 360, and a filtering policy manager 370.

There may exist a data transfer protocol specialized for use in each communication between a server and a client or between a host and a terminal. For example, logging-in may be a transfer protocol and may be required in order to use a service.

A general web mail system may receive an input of an account name and a password from a user. As a number of security threats increases different service providers may utilize different methods to protect data. For example, a first service provider may encode and transmit an account name and a password inputted by a user in a general web mail system, and a second service provider may use an internet personal identification number (iPIN) to protect an account name and password in a general web mail system.

A data organizing scheme, data transmitting scheme, and data receiving scheme, i.e., a data transfer protocol may vary depending on a service design and providing model for each service. A data transfer protocol may be used between a server and a client for each service. If the data transfer protocol is identified, a client for the service may not be limited to a dedicated client, and may include, for example, an open application programming interface (API) published by a large-scale service provider, for example, Google®, Naver®, and the like.

The open API may not correspond to all services. For example, an open API of Google® may publish a data transfer protocol for Google® services, for example, Google Maps®, YouTube®, and the like. The open API of Google® may not allow generation of a client for a Naver® mapping service. This may be because Google® and Naver® have different data transfer protocols.

Accordingly, even though each cloud service may publish a service architecture in the future, aspects of the present invention may be applicable to and accept future cloud services due to an open API for a web service.

Exemplary embodiments of the present invention provide a method that may monitor data transmitted and received through the transmitting/receiving buffer 330, may establish a standard filtering condition for filtering the data, may select a data transfer protocol for the filtering condition, may extract detailed data from the data based on the filtering condition, and may determine whether the detailed data meets the filtering condition, and may block reception and transmission of an inappropriate or bad content.

(1) Data Transmitting/Receiving Unit 320

The data transmitting/receiving unit 320 may communicate with a cloud server 310 via a network, for example, the Internet and the like. The data transmitting/receiving unit 320 may transmit data to and receive data from the cloud server 310 using a communication protocol. The data transmitting/receiving unit 320 may form a module with the transmitting/receiving buffer 330.

The data transmitting/receiving unit 320 may form a module with the filter 350 and the filtering policy manager 370, or may be separately mounted in a client of a cloud service.

(2) Transmitting/Receiving Buffer 330

The transmitting/receiving buffer 330 may act as a data stream pipeline and may improve efficiency of data input to and data output from a file system. The data transmitted and received through the transmitting/receiving unit 320 may be organized into a file format through a file system of a memory installed in a terminal. The file format may be arbitrary. The transmitting/receiving buffer 330 may sequentially transmit the stored data to the data transmitting/receiving unit 320 to transmit data to the cloud server 310 by reading the file stored in the transmitting/receiving buffer 330.

To receive data from the cloud server 310, the content filtering apparatus may record the data stream transmitted through the data transmitting/receiving unit 320 in a new file or an existing file according to a storage rule. The content filter apparatus may sequentially or arbitrarily record the data stream.

The file input and the file output through a storage may cause a system load to increase and may give rise to a bottle neck phenomenon because of a difference between a processing rate of a main memory and an input and output rate of the storage. The transmitting/receiving buffer 330 may be operate between the file system and the data transmitting/receiving unit 320 to reduce the bottle neck phenomenon.

For example, if a main memory has 4 kilobytes (kB) allocated to the transmitting/receiving buffer 330 to receive a video file, in order to transmit data via a network, data may be divided into packets. Even though the transmitting/receiving buffer 330 may have a size set to 4 kB, the entire 4 kB of data may not be transmitted from the server at once.

The client may receive data packets divided from the data based on the size of the communication protocol. Network information, transfer information, and actually received data may be included in the data packets and may have a reduced size. If small data segments are frequently recorded in a file, the entire system processing rate may be reduce according to characteristics of a file input and file output technology. The transmitting/receiving buffer 330 may store a proper size of data and then record a larger size of data in a file simultaneously, in accordance with a reference standard.

The transmitting/receiving buffer 330 may be generated in the main memory by the client. To transmit data, the transmitting/receiving buffer 330 may accumulate data by reading the file from the file system and may fetch the accumulated data and transmit the data to the data transmitting/receiving unit 320. The transmitting/receiving buffer 330 may sequentially fetch the accumulated data.

If a plurality of data streams is generated, a plurality of transmitting/receiving buffers 330 may be generated accordingly. A plurality of transmitting/receiving buffers 330 may be sequentially generated according to a purpose for which the plurality of transmitting/receiving buffers 330 is to be used. The transmitting/receiving buffer 330 may be generated into a transmitting buffer and a receiving buffer.

Depending on the purpose for which the plurality of transmitting/receiving buffers 330 is to be used, the data stream stored in the transmitting/receiving buffer 330 may be just reserved in the memory or temporarily stored in the memory and then used. If a file is received, the transmitting/receiving buffer 330 may sequentially store a data stream, and if a reference size of data is accumulated, may record the data in the file system and then delete the data from the transmitting/receiving buffer 330. If a file is transmitted, the transmitting/receiving buffer 330 may transmit data to the data transmitting/receiving unit 320 and then delete the data from the transmitting/receiving buffer 330.

In a manner similar to pre-buffering of a reference size of data for seamless video play, if a file is to be transmitted or received, the transmitting/receiving buffer 330 may enable favorable data transmission or data reception and file input and file output. The standard for a suitable size of the transmitting/receiving buffer 330 may vary depending on the purpose for which the plurality of transmitting/receiving buffers 330 are to be used and a communication protocol with the server.

The transmitting/receiving buffer 330 may be configured to temporarily accumulate the data in the memory and delete the data. A separate data processing space may be needed for filtering the transmitted data and received data. The filter buffer 340 may perform such a function.

(3) Filter Buffer 340

The filter buffer 340 may correspond to a data stream pipeline to store portions of a data stream to be extracted by the filter 350. The data to be filtered may be disposed in the transmitting/receiving buffer 330. The filter 350 may filter content transmitted and content received via a network, in particular, data and additional information constituting a content file.

The filter buffer 340 may provide a space for copying and storing portions of a data stream in the transmitting/receiving buffer 330 corresponding to a period of time or a size for filtering.

Since the transmitting/receiving buffer 330 cannot directly process a data stream for filtering, the filter buffer 340 may be provided separately, for the filtering.

The transmitting/receiving buffer 330 may be used as a space for temporarily storing data which may improve efficiency in transmitting data and receiving data between the transmitting/receiving unit 320 and the storage. If the transmitting/receiving buffer 330 is flushed during the method for filtering, a data stream may be first flushed and then another data stream may be received such that data being inspected may disappear or may be replaced with new data.

To prevent data of a memory from being updated or disappearing, data recorded in a file may be loaded and filtered. However, since a file input rate and a file output rate of a file system may be lower than that of a main memory and received data needs to be continuously recorded in a file system, the input of the file system and output of the file system may cause an increase in a system load due to simultaneous access to one file and may reduce the performance of the transmitting of data, the receiving of data, and the filtering data.

To load data in a memory for a sufficiently long period of time, the size of the transmitting/receiving buffer 330 may be increased. However, taking the limited resources of a mobile terminal into consideration, increasing the size of the transmitting/receiving buffer 330 without limit, or assigning a large space sufficient to receive the entire data of a desired content including additional information may not be preferable. As a solution, the filter buffer 340 may be used.

Like the transmitting/receiving buffer 330, the filter buffer 340 may be a location where stored data may be deleted by the filter 350 if the data inspection is completed and then new data may be copied from the transmitting/receiving buffer 330. The filter buffer 340 may be generated in a main memory by the filter 350.

The filter buffer 340 may be generated to be larger or smaller than the transmitting/receiving buffer 330 if data transmission and reception is faster than filtering.

The size of the filter buffer 340 may be determined based on a filtering policy, that is, a condition for filtering out an inappropriate content.

A memory pool may correspond to a technology to allocate a memory space of a size into blocks, and to assign a memory block to the filter buffer 340 and return an unnecessary memory block to the pool and store in the pool. If the memory space is once again needed, the blocks stored in the pool may be used.

According to exemplary embodiments, memory usage in a mobile terminal having lower performance than a desk-top computer may be achieved by recycling an already allocated memory, which may thereby reduce overhead involved in newly allocating a memory if a memory space is needed.

(4) Service Profile 361

The service profile 361 may include a token or a data identifier determined based on characteristics and a transfer protocol of each cloud service. The filter 350 may identify data in the transmitted data and the received data based on the token or data identifier.

Content and additional information of the content may be transmitted through one data stream, or the content and the additional information may be transmitted separately, through separate data streams.

The additional information of the content may vary in configuration and format for each cloud service. For example, data may be classified according to a designated tag. For each cloud service, a tag of a different name may be designated to the same data. The tag may be used as metadata of the data.

The content and the additional information of the content may be configured to recognize a data block of a data stream from a reference byte. A reference byte may be used as data having a reference meaning without a separate tag.

A plurality of contents may be transmitted through one data stream at one time, may be separately transmitted through a data stream at different times, or may be transmitted through different data streams.

The filter 350 may identify data of different data streams for each cloud service, using the service profile 361.

The service profile 361 may include a content transmitting procedure, a data stream identity value, a communication protocol to transmit a data stream including, for example, HTTP, FTP, etc., and configuration information of a data stream. The configuration information of the data stream may include information about data. For example, identification information of data may include metadata and a memory block assigned to each data.

The service profile 361 may be used to identify data and extract data to be filtered based on a filtering policy.

The filtering policy may be set for content security by a user, and may correspond to a standard for determining whether an element to be filtered is included in received data. Data to be filtered may be to be identified and extracted from data included in a data stream.

For example, to prevent or reduce the illegal distribution of a film, if a reference film company requests a plurality of cloud service providers to block a file associated with the corresponding film, the cloud service providers may reflect a file name received from the film company on filtering policies.

A tag indicating a file name may be different for each cloud service. Even though the tags indicate the same file name, the tags may have different formats. The filter 350 may map an index indicating a file name to the tags indicating the file name of the service profile 361 in different formats, based on an index mapping table. The filter 350 may unify the tags indicating the file name using the same index.

The filtering policy manager 370 may obtain filtering conditions from various cloud services and may generate a filtering condition database. The filtering policy manager 370 may generate a unified filtering condition list and may update the list by adding a new filtering condition. The filtering policy manager 370 may assign an index to the unified filtering condition list. The filtering condition list having the assigned index may be referred to as the index mapping table.

The mapping of the index to the filtering condition list may be represented in a form of a script, a table, or a regular expression, and may be generated in an executable extension file. The executable extension file may be separate from other files. For example, an extension of the executable extension file may include .exe, .dll, .jar, and the like. The separate extension file may be registered in a plug-in format, and an index mapping program may be executed through connection of plug-ins.

(5) Service Profile Manager 360

The service profile manager 360 may add, delete, and update the service profile 361. In response to a request by the filter 350, the service profile manager 360 may search for the service profile 361 stored in a local storage, and if the service profile 361 is present, may transmit the service profile 361 to the filter 350. If the service profile 361 is absent, the service profile manager 360 may request the service profile 361 from a security operating server or the cloud server 310, may store the service profile 361 in the local storage, and may transmit the service profile 361 to the filter 350.

The service profile 361 may be received from the security operating server or the cloud server 310, or may be directly generated and modified by a cloud service user.

The service profile manager 360 may generate the service profile 361 having a mapped index based on the index mapping table. If the index mapping table is mapped to each service profile 361, configuration information of data streams of different formats may be recognized as identification information.

The service profile manager 360 may determine whether a received service profile is the same as the service profile 361 which may be registered in a service profile DB.

If the received service profile is not registered in the service profile DB, the service profile manager 360 may add the received service profile to the service profile DB.

If a new cloud service is added, the service profile manager 360 may request the service profile 361 of the new cloud service from the server. If the service profile manager 360 fails to receive the service profile 361 from the server, the service profile manager 360 may generate a user-defined service profile.

If a service profile is deleted by a user, the service profile manager 360 may discontinue accessing a cloud service corresponding to the service profile.

(6) Filtering Policy 371

The filtering policy 371 may include a condition for filtering out inappropriate content in a data stream transmitted to and received from the cloud server 310. The filtering policy 371 may correspond to a written form of the filtering condition.

Data or data block corresponding to the filtering condition in the received data stream may be identified through metadata or a reference memory address. The metadata or reference memory address may be in the service profile 361.

The filtering policy 371 may include content shared via a cloud service and additional information of the content, as the filtering condition.

The filtering policy 371 may include location information linked to a location-based service. For example, a region name may be employed as the filtering condition, and transmitting of content and receiving of content associated with a corresponding region may be blocked.

(7) Filtering Policy Manager 370

The filtering policy manager 370 may add, delete, and update the filtering policy 371.

The filtering policy manager 370 may determine whether the filtering policy 371 of a data stream is present, and if the filtering policy 371 is absent, may request the filtering policy 371 from the security operating server or the cloud server 310. The filtering policy manager 370 may determine whether the filtering policy 371 is present when data reception Starts.

The filtering policy manager 370 may verify the filtering policy 371. If the filtering policy 371 of each cloud service is updated, the filtering policy manager 370 may request the filtering policy 371 from each cloud service provider and may update the filtering policy 371.

The filtering policy 371 may be received from the security operating server or the cloud server 310, or may be generated and modified directly by a cloud service user.

(8) Filter 350

The filter 350 may search for a stated object in the filtering policy 371 from the service profile of the cloud service providing the content, based on the filtering policy 371. The filter 350 may extract data corresponding to the stated object for evaluation from the filter buffer 340, and may evaluate the object based on the filtering condition. The filter 350 may control data transmission and reception based on an evaluated result.

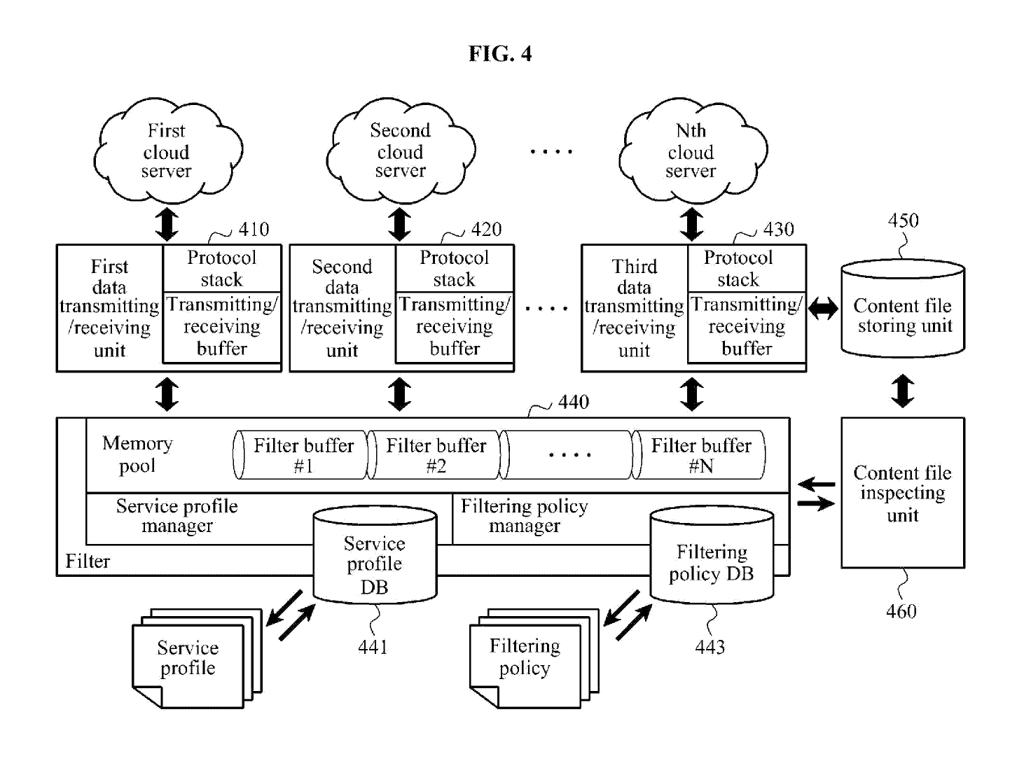

FIG. 4 is a block diagram of a content filtering apparatus according to an exemplary embodiment of the present invention.

Referring to FIG. 4, the content filtering apparatus may include a first data transmitting/receiving unit 410, a second data transmitting/receiving unit 420, a third data transmitting/receiving unit 430, a filter 440, a content file storing unit 450, and a content file inspecting unit 460.

The first data transmitting/receiving unit 410 may transmit content to and receive content from a first cloud service. The first data transmitting/receiving unit 410 may transmit the content and receive the content using a protocol of a first cloud service. The protocol may include an Internet protocol, for example, HTTP, FTP, a domain name system (DNS), and the like. The first data transmitting/receiving unit 410 may include a transmitting/receiving buffer. Information about the protocol may be stored in a protocol stack.

The second data transmitting/receiving unit 420 may transmit content to and receive content from a second cloud service. The second data transmitting/receiving unit 420 may transmit the content and receive the content using a protocol of the second cloud service. The second data transmitting/receiving unit 420 may include a transmitting/receiving buffer. Information about the protocol may be stored in a protocol stack.

The third data transmitting/receiving unit 430 may transmit content to and receive content from an Nth cloud service. The third data transmitting/receiving unit 430 may transmit the content and receive the content using a protocol of the Nth cloud service. The third data transmitting/receiving unit 430 may include a transmitting/receiving buffer. Information about the protocol may be stored in a protocol stack.

In other words, the content filtering apparatus may include a data transmitting/receiving unit and a transmitting/receiving buffer corresponding to each cloud service. The transmitting/receiving buffer may temporarily store data before storing the data in a memory. The temporary storage of the data in the transmitting/receiving buffer may improve data input and data output efficiency.

The data transmitting/receiving unit and the transmitting/receiving buffer of each cloud service may be logically separated in one module. If a new cloud service is added or activated, a data transmitting/receiving unit and a transmitting/receiving buffer corresponding to the new cloud service may be generated.

The data transmitted and received via a network may have packets arranged through a modem and a protocol stack. The packets may be arranged in order through the modem and the protocol stack. If a reference size of the data is reached, the transmitting/receiving buffer may record the data in a file and then may be flushed. The filter 440 may temporarily copy the data accumulated in the transmitting/receiving buffer to a filter buffer.

The filter 440 may include at least one filter buffer, a service profile manager, and a filtering policy manager. The data stored in the transmitting/receiving buffer may be copied to the filter buffer. The filter buffer may consist of memory blocks of a memory pool, and the size of the filter buffer may vary depending on the number of memory blocks. The size of the filter buffer may be variably adjusted according to the number of memory blocks. A filter buffer may be connected to each transmitting/receiving buffer. The filter buffer may store portions of the data accumulated in the transmitting/receiving buffer.

The service profile manager may download a service profile from a service profile DB 441 and may store a service profile in the service profile DB 441. The service profile manager may receive a service profile from the first cloud service, the second cloud service, and the Nth cloud service, respectively.

The filtering policy manager may download a filtering policy from a filtering policy DB 443 and may store a filtering policy in the filtering policy DB 443. The filtering policy may vary depending on the cloud services, and may be common to the cloud services. The filtering policy manager may receive various filtering policies from a cloud service provider or a security operating server.

The filter 440 may detect whether an item matching the determined filtering condition is present in the service profile. If the matched item is present, the filter 440 may extract data to be filtered among the data stored in the filter buffer, based on an identity value of the corresponding item. The filter 440 may determine whether the extracted data meets the filtering condition, and may control data transmission and data reception based on a determined result. If the filtering condition may be set to detect an inappropriate content, the filter 440 may block data being transmitted and received if the data meets the filtering condition.

A client communicating with each cloud service may include the first data transmitting/receiving unit 410, the second data transmitting/receiving unit 420, and the third data transmitting/receiving unit 430 and their respective transmitting/receiving buffers. The filter 440 may include the service profile manager, the filtering policy manager, and the filter buffer.

The client may provide the filter 440 with an access interface to enable the filter 440 to monitor a data transmission status, a data reception status, and a status of a transmitting/receiving buffer. The filter 440 may include a monitoring unit (not shown) to monitor the status of a transmitting/receiving buffer.

The data stored in a transmitting/receiving buffer may be flushed and may be stored in the content file storing unit 450 in a file format. The content file storing unit 450 may be implemented as a file system of an operating system. However, the exemplary embodiments are not limited thereto and the file storage unit 450 may be implemented in any manner.

The content file inspecting unit 460 may inspect the file stored in the content file storing unit 450 using a vaccine, antivirus program, etc. The filter 440 may filter out an inappropriate content from transmitted data and received data, and the content file inspecting unit 460 may detect the inappropriate content from the file. The inappropriate content may be discovered through an external security inspection toll, for example, an antivirus program.

The data may change based on an encoding scheme in consideration of a data transmitting procedure and data receiving procedure and a size of the transmitted data and the received data. In case of a file difficult to filter, for example, a video file, a moving pictures experts group audio layer 3 (“MP3”) audio file, and the like, additional information may be filtered. A third-party security inspection tool may be used to inspect a content file having a relatively large data size, i.e., which may require additional time and storage space to transmit the data and receive the data.

The additional information data requiring relatively less time to transmit the data and receive the data and having a relatively small data size may be inspected before a content file with a relatively larger data size. If a problem is found, the transmitting and the receiving of a content file having a relatively large data size may be blocked. This may prevent or reduce an unnecessary data communication of a mobile terminal and securing a storage space of the mobile terminal.

If the additional information is determined not to be harmful, the filter 440 may record the filtering condition of the inspected data in the service profile, and if an entirety of data accumulated in the filter buffer is determined not to be harmful, may delete the data block from the filter buffer. Subsequently, if new data is copied from the transmitting/receiving buffer, filtering may be repeated based on the entire filtering condition.

If the additional information is determined to be harmful, the filter 440 may disconnect the connection with the cloud service to not receive the data.

The transmission and the reception of a content file may be completed during a process of filtering additional information due to a high data receiving rate. A user may fail to recognize that content is inappropriate and may open the content irrespective of a filtering result, so that a security threatening feature of the content, for example, a Trojan horse, may become active.

If the filtering result reveals harmfulness of the content, the transmission and the reception of data may be blocked, already received data may be deleted from the transmitting/receiving buffer, and the content file being recorded or having been recorded in the file system may be deleted, and may thereby prevent or reduce an unnecessary data communication and securing a storage space.

The security policy and service profile may be received or updated using a PUSH technology, a pull technology, etc.

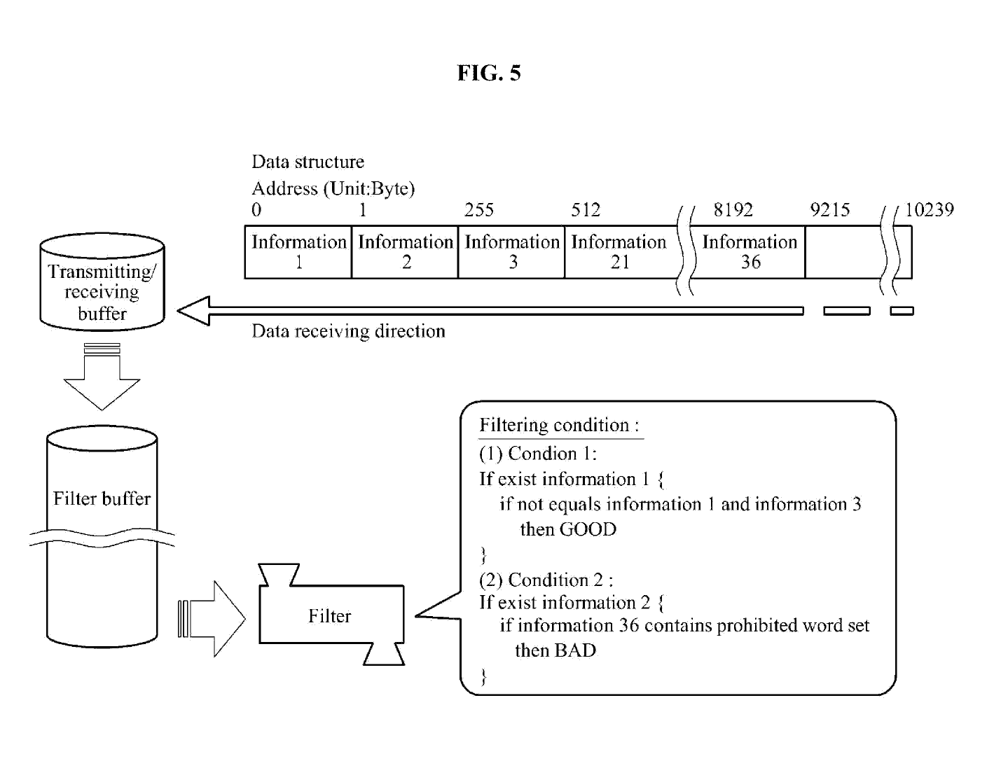

FIG. 5 is a diagram of a method for transmitting received data according to an exemplary embodiment of the present invention.

By way of example, content received from a cloud server may have a size of 10 kB and a transmitting/receiving buffer may have a capacity of 1 kB. Accordingly, the transmitting/receiving buffer cannot receive the entire data of 10 kB at one time. If the transmitting/receiving buffer of 1 kB size is totally filled with the received data, the data transmitting/receiving unit may record the data of 1 kB in a file on a file system, and may clear the transmitting/receiving buffer.

If the transmitting/receiving buffer is filled again, a process of recording newly received data at the end of a previous file and may flush the transmitting/receiving buffer repeatedly. The newly received data may be sequentially recorded at the end of the previous file.

The filter may filter content using a first condition “condition 1” of the filtering condition. Referring to FIG. 5, a data stream may be identified in the unit of a memory block. In other words, information may be identified based on a storage location in a memory. “Information 1” having a size of 1 byte is recorded in a 0th location. “Information 3” having a size of 257 bytes is recorded in a 255th location in the data stream. To receive data having a size of at least 512 bytes that refers to the two data, the filter buffer may have a size of 512 bytes.

The filter may filter content using a second condition “condition 2” of the filtering condition and the transmitting/receiving buffer may have a capacity of 640 bytes.

“Information 36” having a size of 1023 bytes is recorded in an 8192nd location in the data stream. Taking the capacity of the transmitting/receiving buffer into consideration, “Information 36” may be divided into three segments and may be flushed in the transmitting/receiving buffer. The filter buffer may need to have a capacity sufficient to store the entire “Information 36.” However, to filter only “Information 36” having a size of 1023 bytes, assigning 9600 bytes, that is, 640 bytes×15 times, to the filter buffer may result in a space waste of a main memory.

To filter only “Information 1” having a size of 1 byte and “Information 3” having a size of 257 bytes, assigning 512 bytes may also result in space being wasted. The total size of the two data, 258 bytes, may be sufficient.

Since the transmitting/receiving buffer is repeatedly filled and flushed, the size of the filter buffer may be adjusted in consideration of the size of the transmitting/receiving buffer. If an amount of time taken to identify the filtering condition is longer than an amount of time taken to flush the transmitting/receiving buffer, data to process one condition may disappear in the transmitting/receiving buffer while processing another condition.

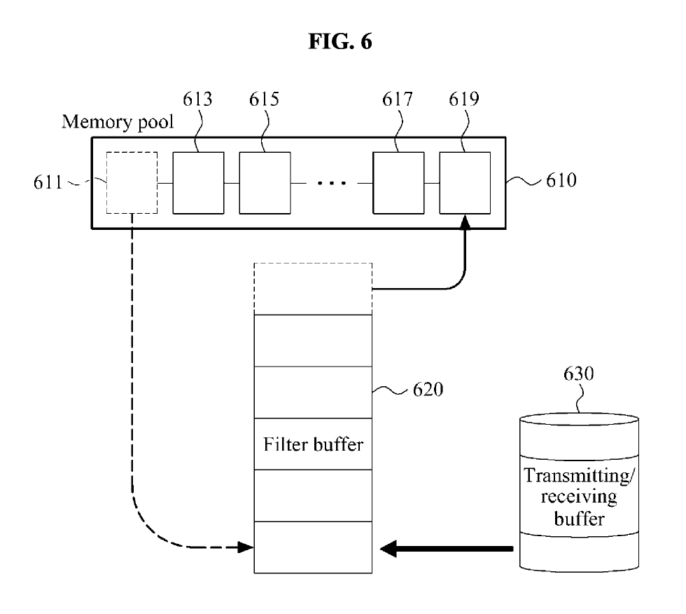

FIG. 6 is a diagram of a method for adaptively adjusting a size of a filter buffer according to an exemplary embodiment of the present invention.

Referring to FIG. 6, a memory pool 610 may include a memory block 611, a memory block 613, a memory block 615, a memory block 617, and a memory block 619.

The memory pool 610 may manage the memory block 611, memory block 613, memory block 615, memory block 617, and memory block 619, in proportion to the size of a transmitting/receiving buffer, in a list structure. If a filter buffer 620 is to copy data from a transmitting/receiving buffer 630 and the filter buffer 620 has an insufficient amount of free space, the filter buffer 620 may request a memory block from the memory pool 610. If a memory block is present in the memory pool 610, the memory pool 610 may assign one of the memory block 611, memory block 613, memory block 615, memory block 617, and memory block 619, for example memory block 611, to the filter buffer 620.

If the space of the filter buffer 620 is still insufficient after the memory block 611 is assigned, the memory block request and assignment may be repeated so that the filter buffer 620 may have a sufficient space to store data copied from the transmitting/receiving buffer 630.

If the filter buffer 620 does not need the stored data any longer, the filter buffer 620 may be flushed. If the filter buffer 620 has free space greater than a set basic size, the filter buffer 620 may return an occupied memory block, for example memory block 619, back to the memory pool 610. If the memory pool 610 receives the memory block 619, the memory pool 610 may manage the memory block 619 as an available block by connecting the memory block 619 to the list. If a request is received from the filter buffer 620, the memory pool 610 may assign an available memory block to the filter buffer 620.

A memory block may have a size corresponding to 1:1, 1:2, 1:4, etc. of the size of the transmitting/receiving buffer 630. The memory pool 610 may include the memory block 611, the memory block 613, the memory block 615, the memory block 617, and the memory block 619, and may assign the memory block to the filter buffer 620 in response to a request by the filter buffer 620. The memory block 611, the memory block 613, the memory block 615, the memory block 617, and the memory block 619 may be allocated to the memory pool 610 before a request by the filter buffer 620. The number and size of the memory blocks may be determined based on an available resource and the efficiency of the content filtering system.

The number of the memory blocks to be assigned from the memory pool 610 to the filter buffer 620 may be adjusted in consideration of a size of data being processed, an amount of time taken to identify the filtering condition, an amount of time taken to flush the transmitting/receiving buffer 630. The number of memory blocks to be assigned from the memory pool 610 may be adaptively adjusted.

The memory blocks may be identified by setting the number of buffer pointers corresponding to the number of the memory blocks to the transmitting/receiving buffer 630. This may reduce the overhead involved in individually generating a filter buffer.

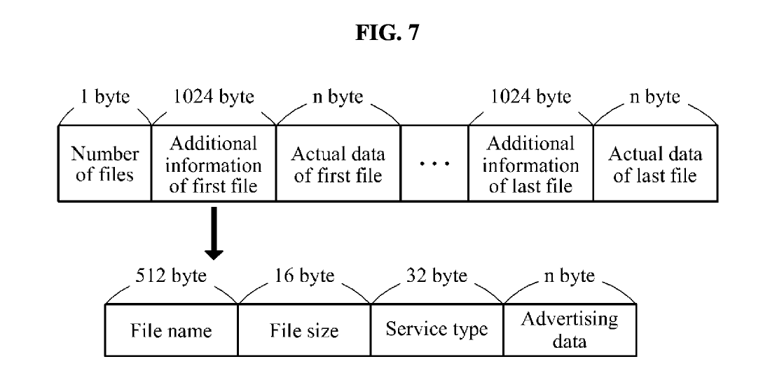

FIG. 7 is a diagram of a data stream according to an exemplary embodiment of the present invention. The data stream of FIG. 7 may be transmitted and received by a content filtering apparatus.

Referring to FIG. 7, data of a data stream may be identified based on a location and a size of a data block. A first data block having a size of 1 byte may indicate the number of files included in the data stream, i.e., the number of contents.

A second data block having a size of 1024 bytes may include additional information of a first file. The additional information of the first file may include information associated with the file, for example, a name of the file, a size of the file, a creation data of the file, a type of the file, a service type, advertising data, and a creator of the file. A third data block having N bytes may include actual data, i.e., content.

The data stream may be segmented into blocks. The number of blocks may correspond to the number of files.

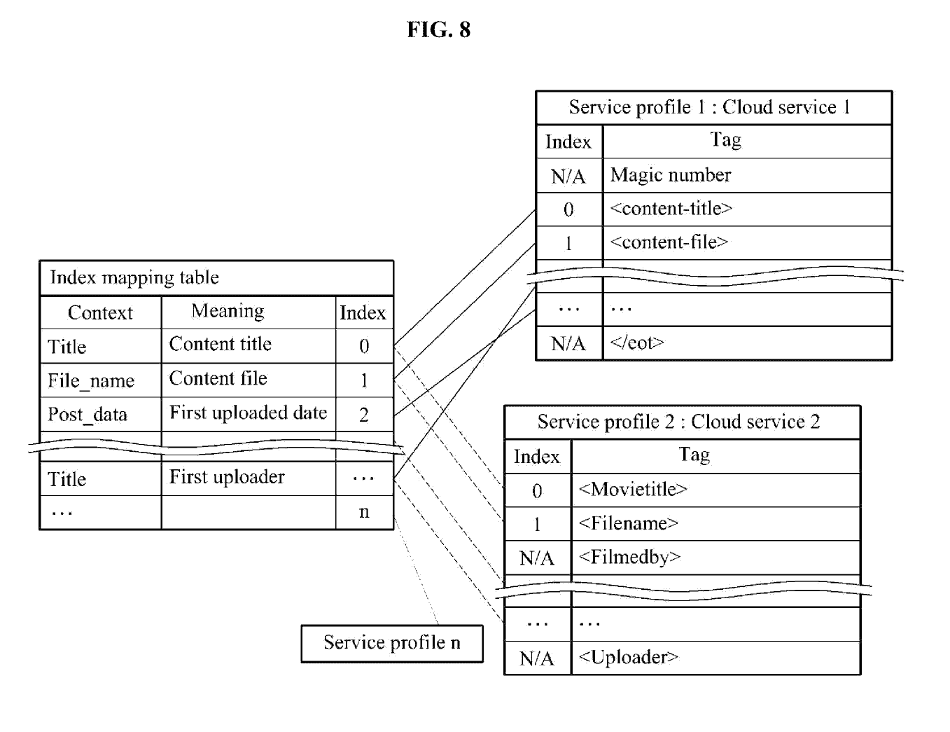

FIG. 8 is a diagram of a method for re-generating a service profile according to an exemplary embodiment of the present invention.

Referring to FIG. 8, an index mapping table, a first service profile, a second service profile, a n^{th} service profile are depicted. A service profile, such as, service profile 1, service profile 2, service profile n, may include a transfer protocol of each cloud service and the index mapping table may be mapped to the transfer protocol.

Each cloud service may have a unique data structure and it may be difficult to apply a common filtering policy to various cloud services.

Accordingly, if service profiles of the cloud services are generated using a standard table, the cloud services may have re-generated service profiles of a standard type based on the standard table. If a new cloud service is added, it may be possible to simply utilize the new cloud service by adding a service profile of the new cloud service based on the standard table.

The standard table may be generated to reflect all filtering policies by referring to the filtering policies of the cloud services, and by unifying similar types of filtering policies into one and adding a different type of filtering policy.

The standard table may include, for example, an index mapping table. The index mapping table may include a filtering policy, a meaning of the filtering policy, an index assigned to each filtering policy, etc. The index may be mapped to each tag of a service profile based on the index mapping table to generate a new service profile, for each cloud service.

For example, a standard term of a filtering policy corresponding to <content-title>, as exemplified in the first cloud service, and <movietitle> as exemplified in the second cloud service, may correspond to <title> in the index mapping table. An index ‘0’ of <content-title> corresponding to the standard term <title> may be mapped as an identifier of metadata <content-title> about a structure of received data in the service profile of the first cloud service. The index ‘0’ of <movietitle> corresponding to the standard term <title> may be mapped as an identifier of metadata <movietitle> of the second cloud service. A corresponding index of the standard term may be mapped to each metadata tag.

The index mapping table may be set by a security manager, a service user, a service provider, etc. If a new cloud service is added, an index of the standard term may be mapped to a new service profile, thereby recognizing information about metadata in a data field included in a data stream being transmitted to and received from an arbitrary cloud server and a location of binary data corresponding to an actual content file in the data stream.

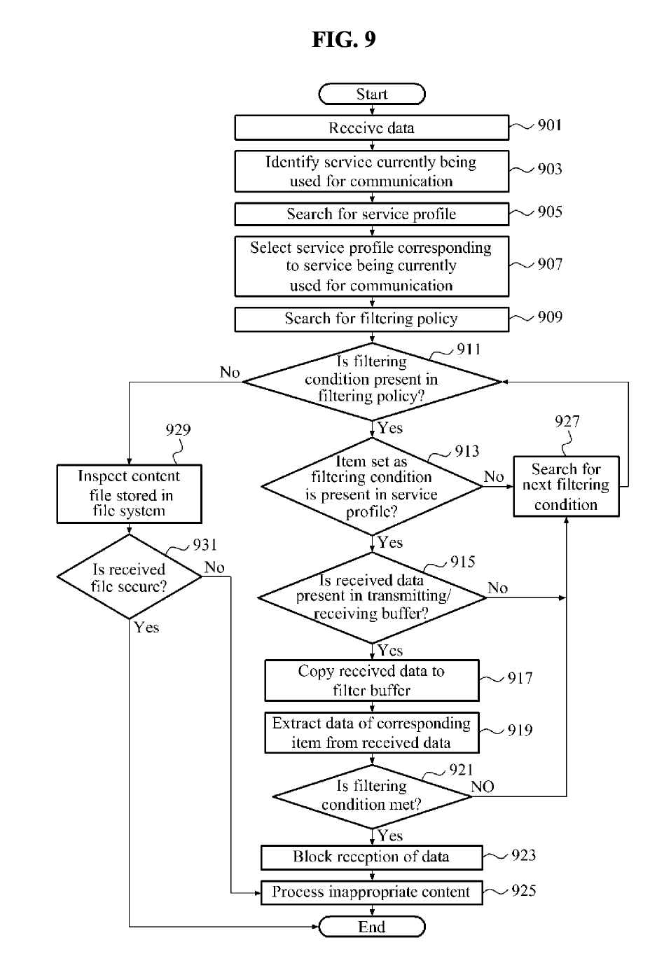

FIG. 9 is a flowchart of a method for content filtering according to an exemplary embodiment of the present invention.

In operation 901, the content filtering apparatus may receive data from a cloud server.

In operation 903, the content filtering apparatus may identify a cloud service being used for communication. The content filtering apparatus may identify a type of a cloud service providing the content. The content filtering apparatus may identify a cloud service and may request a service profile from a service profile manager.

In operation 905, the content filtering apparatus may search for the service profile. The content filtering apparatus may search for the service profile matching the cloud service being used for communication, using the service profile manager. The service profile manager may search for the service profile matching the cloud service based on the content supported by the cloud service and identification information of the cloud service.

In operation 907, the content filtering apparatus may select the service profile corresponding to the cloud service being used for communication.

In operation 909, the content filtering apparatus may search for a filtering policy.

In operation 911, the content filtering apparatus may determine whether the filtering condition is present in the filtering policy. The filtering policy may be set in each of various cloud services, or one united filtering policy may be shared between the cloud services. The filtering condition may correspond to a condition for an bad content. For example, the filtering condition may correspond to a condition for content with a slang, a reference video file name, a malicious code name, an inappropriate code name, and the like. The filtering condition may correspond to a reference condition set by a user.

In operation 913, if the filtering condition is present in the filtering policy, the content filtering apparatus may determine whether an item set as the filtering condition is present in the service profile. The content filtering apparatus may determine whether the item set as the filtering condition is present in the service profile, based on an index mapped to the service profile. In the index mapping table, the index may be assigned for each filtering condition or each filtering policy. The content filtering apparatus may compare the index of the filtering condition to the index mapped to the service profile, and if the same index is present, may determine that the item set as the filtering condition is present.

In operation 915, if the item set as the filtering condition is present in the service profile, the content filtering apparatus may determine whether the received data is present in a transmitting/receiving buffer.

In operation 917, if the received data is present in a transmitting/receiving buffer, the content filtering apparatus may copy the received data to the filter buffer. The filter buffer may have a size that may be adjusted based on a size of the transmitting/receiving buffer and a size of the received data that is to be filtered. The size of the filter buffer may be variably adjusted.

In operation 919, the content filtering apparatus may extract data corresponding to the item set as the filtering condition from the received data stored in the filter buffer. The content filtering apparatus may extract the data based on metadata or data block information of the service profile.

In operation 921, the content filtering apparatus may determine whether the extracted data of the content meets the filtering condition. The content filtering apparatus may filter additional information having a relatively small data size, based on a conditional expression of the filtering condition selected in the filtering policy.

In operation 923, if it is determined that the content meets the filtering condition, the content filtering apparatus may block reception of the data from the cloud service.

In operation 925, the content filtering apparatus may process the content being received as an inappropriate content by deleting the data stored in the filter buffer and the transmitting/receiving buffer and the file stored in the file system.

In operation 927, if the item set as the filtering condition is absent from the service profile, the content filtering apparatus may search for a next filtering condition in the filtering policy.

In operation 929, if the filtering condition is absent in the filtering policy, the content filtering apparatus may inspect the content file stored in the file system through a security program. The security program may correspond to a third-party program, for example, an antivirus program, that is programmed to search for an inappropriate content.

In operation 931, the content filtering apparatus may determine whether the received file, i.e., the content file is secure, based on the inspected result. If the content file is determined not to be secure, the process may move to operation 925. If the content file is determined to be secure, the content filtering apparatus may continue receiving the content.

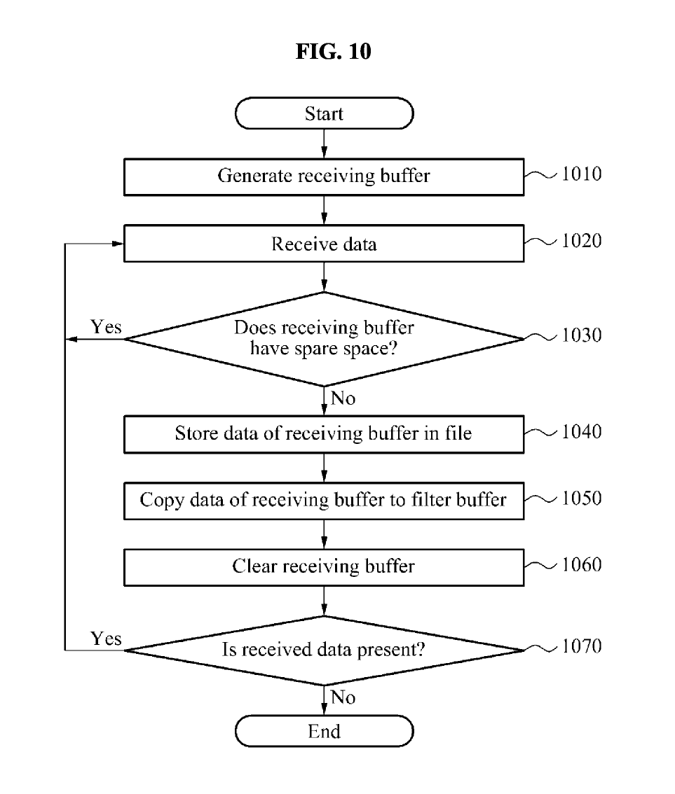

FIG. 10 is a flowchart of method for data buffering according to an exemplary embodiment of the present invention.

In operation 1010, the content filtering apparatus may generate the receiving buffer. The receiving buffer may improve data input and data output efficiency. The receiving buffer may temporarily store a reference size of data received through the data transmitting/receiving unit.

In operation 1020, the content filtering apparatus may receive data from a cloud server via a network. Here, the data may include content.

In operation 1030, the content filtering apparatus may determine whether the receiving buffer has an amount of spare space sufficient to temporarily store the received data.

In operation 1040, if the receiving buffer has a sufficient amount of spare space, the content filtering apparatus may continue receiving the data and store the data in the receiving buffer. If the receiving buffer has an insufficient amount of spare space, the content filtering apparatus may store the data of the receiving buffer in the file system in a file format. The receiving buffer may be flushed.

In operation 1050, the content filtering apparatus may copy the data of the receiving buffer to the filter buffer. The filter buffer may have a size that may be variably adjusted based on a size of the receiving buffer and a size of the data that is to be filtered.

In operation 1060, if the filter buffer has an insufficient amount of spare space, the content filtering apparatus may clear the filter buffer by flushing the data stored in the filter buffer. If the data stored in the filter buffer is determined to be bad data, the content filtering apparatus may clear the filter buffer.

In operation 1070, the content filtering apparatus may determine whether data is continuously received. If data is continuously received, the process may move to operation 1020. If reception of data is completed, the method ends.

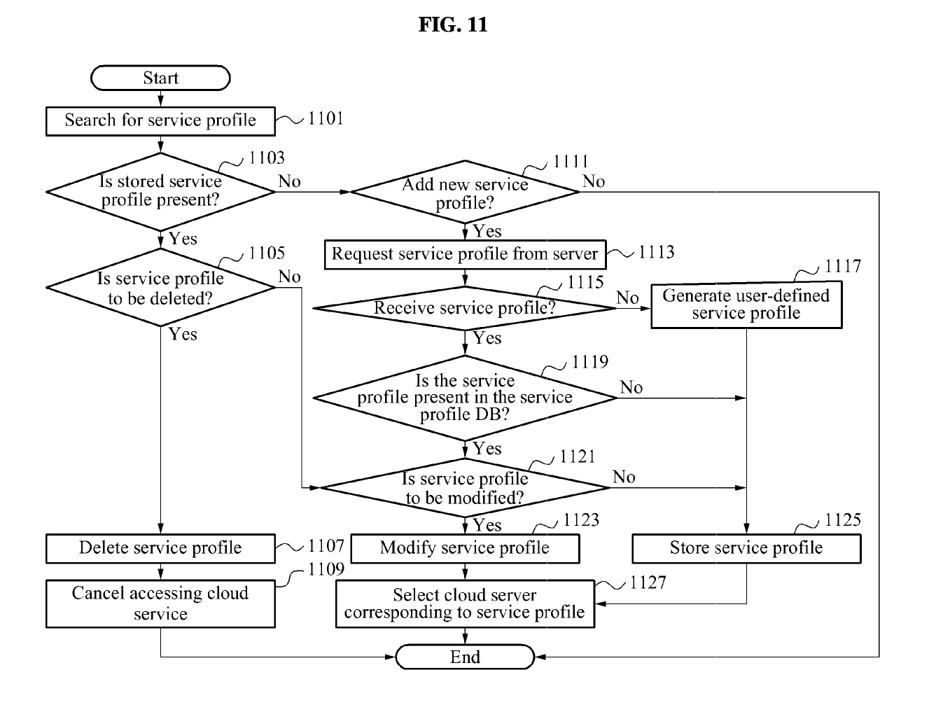

FIG. 11 is a flowchart of a method for searching, modifying, and generating a service profile according to an exemplary embodiment of the present invention.

In operation 1101, the service profile manager may search for a service profile if transmitting data, receiving data, or if a request is received from the filter. The service profile may be stored in the local storage or the service profile DB. The service profile manager may search for a service profile when beginning transmitting data or receiving data.

In operation 1103, the service profile manager may verify whether the stored service profile is present in the service profile DB.

In operation 1105, if the stored service profile is present, the service profile manager may determine whether to delete the stored service profile. If the service profile manager determines the service profile is to be deleted, the service profile manager may determine not to receive content from a corresponding cloud service.

In operation 1107, if the service profile manager determines the service profile is to be deleted, the service profile manager may delete the service profile.

In operation 1109, the data transmitting/receiving unit may discontinue accessing the cloud service corresponding to the deleted service profile.

In operation 1111, if the stored service profile is absent in the service profile DB, the service profile manager may determine whether to add a new service profile. The standard for determining whether to add a new service profile may include determining whether a new registered cloud service is present, determining whether configuration information of a new data stream is present, and the like.

In operation 1113, if the service profile manager determines to add a new service profile, the service profile manager may request the new service profile from a security operating server or a server providing each cloud service.

In operation 1115, the service profile manager may verify whether the new service profile is received.

In operation 1117, if the service profile manager fails to receive the new service profile, the service profile manager may generate a user-defined service profile. The user-defined service profile may correspond to a service profile set by a user.

In operation 1119, if the service profile manager receives the new service profile, the service profile manager may determine whether the service profile is stored in the service profile DB.

In operation 1121, if the service profile is stored in the service profile DB, the service profile manager may determine whether to modify the service profile according to a filtering condition of a filtering policy.

In operation 1123, if the service profile manager determines to modify the service profile, the service profile manager may modify the service profile.

In operation 1125, the service profile manager may store the user-defined service profile in the service profile DB.

In operation 1127, the service profile manager may select a cloud server corresponding to the modified service profile or the generated user-defined service profile.

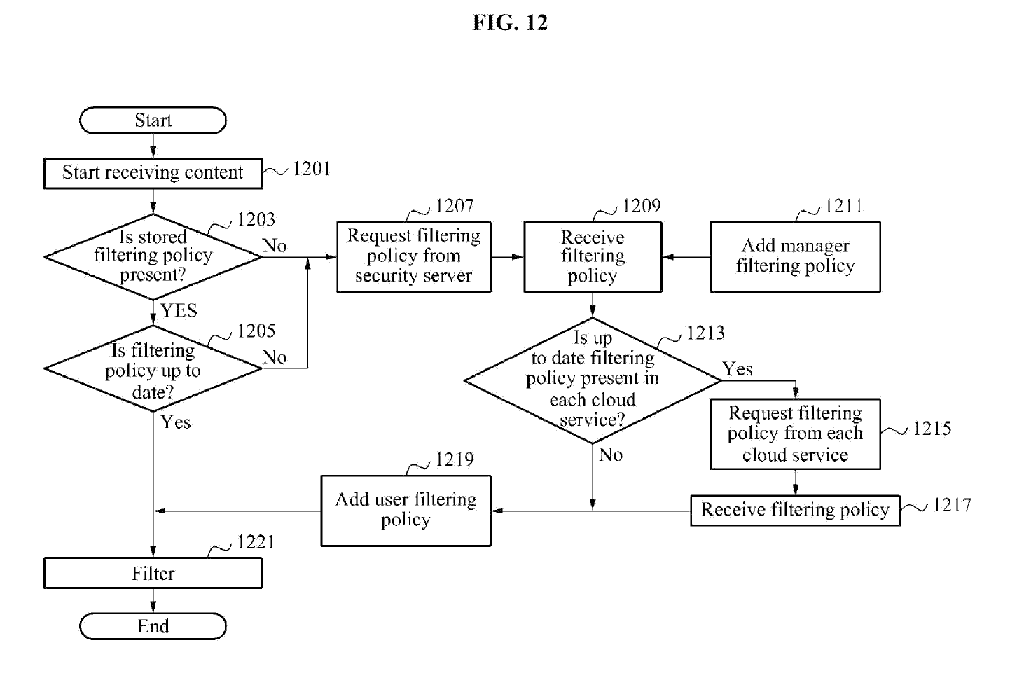

FIG. 12 is a flowchart of a method for searching and adding a filtering policy according to an exemplary embodiment of the present invention.

In operation 1201, the content filtering apparatus may receive content from a cloud server via a network.

In operation 1203, the filtering policy manager may determine whether a stored filtering policy is present in the filtering policy DB, along with identification information of the cloud service.

In operation 1205, if the stored filtering policy is present, the filtering policy manager may determine whether the stored filtering policy is an up to date filtering policy.

In operation 1207, if the stored filtering policy is not an up to date filtering policy, the filtering policy manager may request an up to date filtering policy from the security server.

In operation 1209, the filtering policy manager may receive the up to date filtering policy from the security server.

In operation 1211, the security server may receive an additional filtering policy from a manager of the security server.

In operation 1213, the filtering policy manager may determine whether an up to date filtering policy is present in each cloud service.

In operation 1215, if an up to date filtering policy of each cloud service is present, the filtering policy manager may request the up to date filtering policy from each cloud service.

In operation 1217, the filtering policy manager may receive the up to date filtering policy from each cloud service.

In operation 1219, the filtering policy manager may additionally receive a user filtering policy set by a user.

In operation 1221, the filter may perform a filtering operation based on the up to date filtering policy updated through the security server and each cloud service.

The exemplary embodiments according to the present invention may be recorded in non-transitory computer-readable media including program instructions to implement various operations embodied by a computer. The non-transitory computer-readable medium may include, alone or in combination with the program instructions, data files, data structures, and the like. The non-transitory computer-readable medium and program instructions may be those specially designed and constructed for the purposes of the present invention, or they may be of the kind well-known and available to those having skill in the computer software arts. Examples of non-transitory computer-readable media include magnetic media such as hard discs, floppy discs, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

The exemplary embodiments may re-generate a service profile corresponding to each cloud service having different customized security policies in a united form based on an index mapping table, and may commonly apply the united security policy to the different cloud services.

The exemplary embodiments may filter additional information earlier than actual data in a data stream of content at the time of receiving the data, so that a malicious content may be filtered out before the content is stored in a file format.

The exemplary embodiments may use a filter buffer having a variable size depending on a filtering condition, so that a mobile terminal having a limited memory capacity may efficiently filter files of various cloud services.

The exemplary embodiments may add a desired filtering policy and re-generate a unified service profile based on the added filtering policy, thereby changing a filtering condition more easily and reinforcing security.

The exemplary embodiments may block transmission and reception of data of content determined to be a malicious content, and may thereby prevent or reduce unnecessary content storage and unnecessary data communication from occurring.

The exemplary embodiments may provide a virtual united cloud using a single client including a cloud plug module corresponding to each cloud service, thereby eliminating the need for a dedicated client for each cloud service.

The exemplary embodiments may enable content sharing between cloud services using a virtual united cloud, thereby facilitating expansion of a client to a new cloud service.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A content filtering apparatus, comprising:
a receiving unit to receive a data stream including contents from at least one cloud server;
a filtering unit to filter the content based on a service profile and a filtering condition corresponding to the at least one cloud server; and
a control unit to search for data, in the data stream, associated with the filtering condition based on an index of the service profile matching the filtering condition.

2. The apparatus of claim 1, further comprising:
a receiving buffer to store the data stream; and
a filtering buffer to store a copy of the data stream stored in the receiving unit,
wherein the filtering unit filters the copied data stream stored in the filtering buffer.

3. The apparatus of claim 2, wherein the receiving buffer stores a portion of the data stream and, if the receiving buffer is filled, the data stream stored in the receiving buffer is transferred to a file and the receiving buffer is flushed.

4. The apparatus of claim 2, wherein the control unit adjusts a number of memory blocks assigned to the filter buffer according to the filtering condition.

5. A method for filtering inappropriate content, comprising:
receiving a data stream from a cloud service including a service profile of the cloud service;
determining a filtering policy to filter the data stream including a filtering condition;
mapping the service profile to the filtering policy to generate an index mapping table;
determining if the data stream meets the filtering condition using the index mapping table; and
blocking reception of the data stream if the filtering condition is met.

6. The method of claim 5, further comprising:
deleting downloaded data of the data stream if the data stream meets the filtering condition.

7. The method of claim 5, wherein a portion of the data stream is temporarily stored in a receiving buffer and the stored portion of the data stream is copied and stored in a filter buffer.

8. The method of claim 6, wherein determining if the data stream meets the filtering condition using the index mapping table comprises determining if the copied portion of the data stream in the filter buffer meets the filtering condition.

9. A method for buffering content in a mobile terminal, comprising:
generating a receiving data buffer;
receiving a data stream including content in the receiving data buffer;
storing a copy of the content stored in the receiving data buffer in a filter buffer;
determining if the copied content in the filter buffer meets a filtering condition of a filtering policy; and
if the filtering condition is met, blocking the reception of data in the receiving buffer.

10. The method of claim 9, further comprising:
determining if the receiving data buffer is full;
storing the content in the receiving data buffer in a file system if the receiving data buffer is full; and
flushing the receiving data buffer, if the receiving buffer is full.

11. The method of claim 9, further comprising:
deleting the copied content in the filter buffer if the filtering condition is met.

12. The method of claim 11, further comprising:
deleting the content in the file system if the filtering condition is met.

13. The method of claim 10, wherein a size of the filtering buffer adjusts according to the size of data in the receiving buffer.

14. A method of generating a standard service profile, comprising:
receiving a first service profile of a first cloud service;
mapping an index of the first service profile to an index mapping table of the standard service profile;
determining if the first service profile is to be modified according to the standard service profile;
modifying the first service profile according to the standard service profile if the first service profile is to be modified; and
storing the mapped index of the first service profile.

15. The method of claim 14, wherein receiving the first service profile of the first cloud service comprises:
determining if the first service profile is stored in a filtering policy database;
requesting the first service profile if the first service profile is not stored in the filtering policy database;
receiving a user filter policy;
filtering the first service profile according to the user filter policy.

16. The method of claim 14, further comprising
receiving content of a second cloud service;
determining if the content includes a second service profile of the second cloud service;
requesting the second service profile if the second service profile is not included in the content;
determining if the second service profile is up to date; and
updating the second service profile if the second service profile is not up to date.

17. The method of claim 16, further comprising:
determining if the second service profile is to be modified according to the standard service profile;
modifying the second service profile according to the standard service profile if the second service profile is to be modified; and
storing the mapped index of the second service profile.
